(19) United States
(12) Patent Application Publication
(10) Pub. No.: US 2025/0170662 A1
(43) Pub. Date: May 29, 2025

(54) METHOD AND DEVICE FOR PRODUCING UNDERCUTS AND GEARWHEELS

(71) Applicant: Profilator GmbH & Co. KG, Wuppertal (DE)

(72) Inventor: Karsten ZIMMERMANN, Wuppertal (DE)

(73) Assignee: Profilator GmbH & Co. KG, Wuppertal (DE)

(21) Appl. No.: 18/840,948

(22) PCT Filed: Feb. 14, 2023
(86) PCT No.: PCT/EP2023/053582

§ 371 Date: Aug. 23, 2024

(30) Foreign Application Priority Data
Feb. 24, 2022 (DE) 10 2022 104 454.8

(51) Int. Cl. B23F 1/06

(52) U.S. Cl. CPC B23F 1/06

(57) ABSTRACT

A device and a method for the production of a gearwheel include a first step at which a toothing including teeth with tooth flanks is produced by hob peeling, a second step in which protuberances are produced in the region between a tooth root of the teeth and a root-shaped circle by a material-removing method, and a third step, at which undercuts are produced in the tooth flanks only in one or a plurality of first portions of the width of the toothing. In order to increase the stability of the teeth of the toothing, the protuberances extend only over second portions of the width of the tooth, each of which has an overlapping region with the first portion.

### FIELD OF TECHNOLOGY

The invention relates to a method for producing of a gearwheel comprising a first step, in which a toothing comprising teeth having tooth flanks is produced by a hobbing machining method for example, such as hob peeling, a second step, in which protuberances are produced in the region between a tooth root of the teeth and a root-forming circle by a machining process, and a third step, in which undercuts are produced in the tooth flanks only in one or more first portions of the width of the toothing.

The invention also relates to a device for carrying out the method.

### PRIOR ART

DE 10 2005 049 528 A1 describes a device and a method for producing sliding sleeves. At a first method step, an internal toothing is produced in a ring-shaped workpiece by hob peeling. Undercuts are incorporated into portions of the width of the tooth flanks of the toothing produced in this way. This is done with an undercutting tool.

DE 100 02188 A1 describes a undercutting tool that comprises cutting edges and is torsionally driven around an axis of rotation that runs parallel to the axis of rotation of the workpiece.

DE 10 2008 037 514 A1 describes the production of gear toothings using a hob peeling device.

Devices for hob edging and the hob peeling method are also described in WO 2012/152660 A1 and EP 2 537 615 A1, wherein the latter of which discloses a hob peeling method in which grooves can be incorporated locally into a toothing.

In hob peeling, the hob peeling wheel comprises a toothing that forms a plurality of cutting teeth, wherein each cutting tooth comprises two cutting teeth adjacent to an end face. During the hob peeling machining process, the hob peeling wheel engages into the toothing of the workwheel in the manner of a helical gear mechanism. The tool axis and the workpiece axis are skewed to one another during hob peeling machining process. If the hob peeling wheel has a cylindrical shape, the tool axis must be slightly inclined away from the workpiece axis to create a kinematic clearance angle. This is not necessary when using a truncated conical hob peeling wheel. Here, the shortest spacing distance between the two skewed axes can pass through the point of contact of the tool on the workpiece. During hob peeling, the tool can be advanced in the direction of the width extension of the teeth. Material removal is mainly carried out in the axial direction of the tool.

Sliding sleeves, such as those used in motor vehicle transmissions, are formed by internally gearwheels in which the tooth flanks comprise undercuts. The undercuts are recesses running over a portion of the width extension of the tooth flanks. In the production of these undercuts with a undercutting tool, as described in the above-mentioned DE 100 02 188 A1, the cutting teeth of the undercutting tool, which move on a cycloidal path, engage radially and with an azimuthal movement component in the tooth flank. Due to the shape of the undercuts and the trajectory of the cutting edge, unfavourable cutting conditions result in the region of the tooth flank close to the tooth root. By means of a protuberance, which is introduced into the region of the tooth flank adjacent to the tooth root, material is removed there so that the cutting conditions there improve. In the prior art, the protuberance extends over the entire width of the tooth so that the tooth is weakened.

### SUMMARY OF THE INVENTION

The object of the invention is to specify measures which, on the one hand, improve the cutting conditions for incorporating the undercuts and, on the other hand, avoid weakening of the tooth to the furthest extent possible.

The solved is solved by means of the invention specified in the claims, wherein the sub-claims are not only favourable further embodiments of the invention specified in the secondary claims, but also separate solutions to the task at hand.

Initially, it is essentially proposed that the protuberances reducing the material thickness of the tooth root extend only over a portion of the width of the tooth flanks, namely only over a width range in which the undercuts also extend. The width range of the undercuts overlaps with the width range of the protuberances. In particular, it is provided that a first portion of a width of the toothings will have the undercuts. The portion can be 10%, 20% or 30% of the width of a tooth flank. The protuberance also extends only over a portion of the width of the toothing. This second portion can have the same width extension as the first portion in which the undercut is located. However, it is sufficient if the two portions overlap so that an overlapping region is formed. The toothing is preferably produced by hob peeling. The toothing can be produced using the well-known gear-tooth-cutting methods, in particular, hobbing machining ones. Methods such as shaping, broaching, milling, in particular, hobbing and, being particularly preferred for internal toothing, hob peeling can be considered here. The protuberances can be produced using similar methods, and in particular, the method of hob peeling, hobbing or shaping. However, machining the tooth flank using an end mill can also be considered. Methods such as those described in DE 103 29 413 A1 or DE 10 2014 108 438 A1 can be used for undercuts. In this method, an undercutting tool can be used that has at least one cutting edge. In a preferred exemplary embodiment, not only the toothing is produced by hob peeling, but also the protuberances are produced using the hob peeling method. The hob peeling tool then only engages into the second portion of the tooth flanks that have already been machined at the first method step. In accordance with a further embodiment of the method, the contours of the cutting edges of the cutting teeth of the two hob peeling tools are different from each other. The cutting edge of the hob peeling tool used to produce the toothing can have a section that works the region of the tooth flank adjacent to the tooth head of the tooth of the tooth of the tooth. This foot section of the cutting tooth has a greater thickness than the corresponding section of the cutting tooth of the second hob peeling tool used to produce the protuberance. The foot section of the cutting tooth of the second hob peeling tool is therefore slimmer than that of the first hob peeling tool. It is repositioned in the region of the involute in such a way that no machining takes place there. During the production of the protuberance, therefore, no material removal occurs in the region of the tooth of the workpiece close to the tooth head. With regard to the contour of the cutting edges in the region of the section with which the region of the tooth of the tooth of the tooth adjacent to the tooth root is machined, it is precisely the other way around. The section of the cutting tooth that produces the protuberances, meaning the head section there, is thicker than the corresponding section of the first tool with which the toothing is produced. It can also be provided that the cutting tooth that produces the protuberance has a greater height than the cutting tooth with which the tooth is made at the first step. In such an embodiment, the protuberance can then extend not only over the region of the tooth flank adjacent to the tooth root, but also over the tooth root. In a third method step, the undercuts are essentially prepared in accordance with the method described in DE 100 02 188 A1. While, during the first two method steps, which are hob peeling method steps, the axes of the torsion-driven workpiece and the torsion-driven tool are skewed to each other, the two axes can run parallel to each other when producing the undercuts. Feeding can be carried out in the radial direction in relation to the workpiece. If the tooth flanks each have two undercuts, these two undercuts can be produced simultaneously. For this purpose, a torsionally driven cutter head of the undercutting tool can comprise a plurality of cutting edges, which are arranged in an axial direction one after the other. The undercutting tool can be a gearwheel-shaped tool. However, the undercutting tool can also comprise only one or a plurality of individual cutting edges. The undercutting tool can also be designed in such a way that only one cutting edge is provided for each undercut.

The device according to the invention is essentially a CNC machine with a plurality of axes. The device can have a torsion-driven workpiece axis, a torsion-driven first tool axis carrying the hob peeling tool for producing the gear, a torsion-driven second axis carrying the hob peeling tool for producing the protuberances, and a third axis of rotation carrying the undercutting tool which can be driven by an axis of rotation. The three tool axes can be fed to the workpiece or positioned on the workpiece in a controlled manner by a control device. They can be set into a rotation using the control device, which is synchronized with the rotation of the workpiece, which is also initiated by the control device. They can also be advanced in relation to the workpiece using the control device. The control device is programmed in such a way that, when the device is in operation, a gearwheel is produced in accordance with the method features described above.

### BRIEF DESCRIPTION OF THE DRAWINGS

An exemplary embodiment of the invention is explained below by means of the attached drawings. The drawings show:

FIG. 1 a hob peeling device in accordance with DE 10 2005 049 528 A1, with which both the gear toothing can be introduced at a first method step and protuberances can be introduced into the gear toothing at a second method step, in a sectional first view,

FIG. 2 the tool/workpiece arrangement in accordance with FIG. 1 in a view rotated by 90 degrees,

FIG. 3 a device for producing undercuts, as described in DE 100 02 188 A1, with which, at a third method step, undercuts are introduced into the gear toothing at the points where the protuberances were produced at the second method step,

FIG. 4 a view of the tool/workpiece arrangement shown in FIG. 3 rotated by 90 degrees.

FIG. 5 a partial section through a gear toothing, wherein the reference number 11 in the region of a tooth root 10 refers to protuberances that locally reduce the thickness of the tooth,

FIG. 6 an illustration with the direction of view VI in FIG. 5 on a tooth flank 8 of a tooth 6,

FIG. 7 an illustration in accordance with FIG. 5 but after producing of the protuberances 11 and before the producing the undercuts 12,

FIG. 8 an illustration with direction of view VIII in FIG. 7,

FIG. 9 an illustration with direction of view IX in FIG. 7 and

FIG. 10 the progression of a cutting edge 16 of a cutting tooth of a first hob peeling tool with which the gear toothing is produced and a cutting edge 19 of a cutting tooth of a second hob peeling tool with which the protuberance is produced.

### DESCRIPTION OF THE EMBODIMENTS

By means of a CNC machine tool which comprises a plurality of motor-driven axes and in which, in particular, a workpiece 1 to be geared internally is held in a chuck of a workpiece spindle, a toothing 5 is incorporated into the workpiece 1 using a hob peeling method by means of a first peeling tool 3, which is torsionally driven by a first tool axis. In an exemplary embodiment (not shown), externally toothed work wheels can also be provided with a toothing.

The tool axis 4 of tool 3 is tilted at an axis intersection angle Z with respect to the workpiece axis 2 of workpiece 1. When using a cylindrical tool 3, as is the case in the exemplary embodiment, the tool axis 4 can also comprise an angle of inclination n to the tool axis 2.

By means of a synchronous rotation of workpiece 1 and tool 3 and a simultaneous axial feed movement, an internal toothing with a width B extending over the axial width of workpiece 1 is produced in workpiece 1.

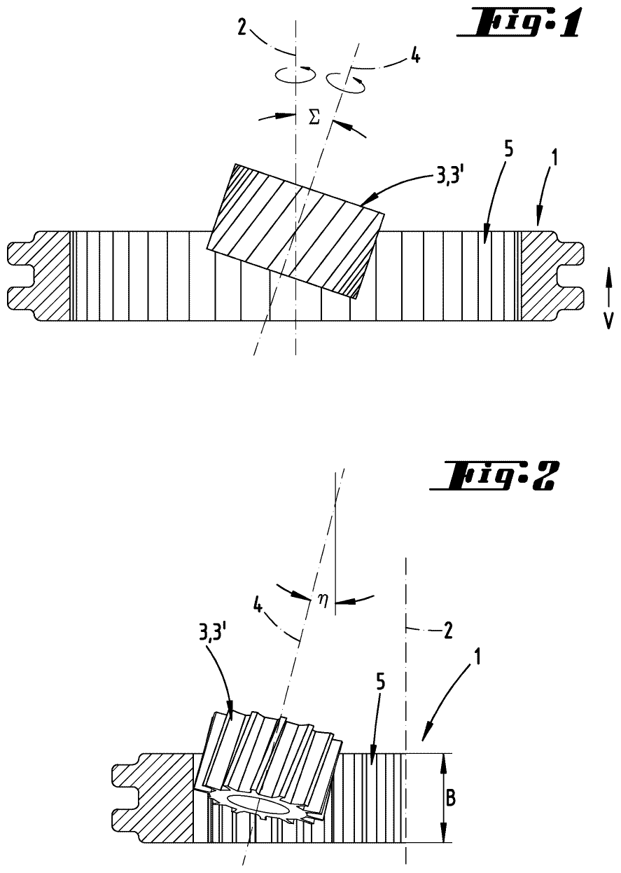

Following this first method step, a second hob peeling tool 3′, which is supported by the same or a second tool axis, is also used in the hob peeling method to introduce at least one protuberance 11 into the tooth flanks 8 of the gear 5 produced at the first method step. FIGS. 1 and 2 show both the first method step as well as the second method step. Firstly, the second method step differs from the first method step by the hob peeling tool used. The main difference, however, is that the second hob peeling tool only engages in the tooth flanks 8 of the tooth 5 in some regions.

After positioning the second tool 3′, in which the cutting edges within the width extension of the tooth 5 are brought into attack against the tooth 5, a radial feed is first carried out, during which the cutting edges of the second cutting tool 3′ enter the tooth flanks 5 in order to remove the protuberances 11 by removing material from the tooth flanks 5 in an region adjacent to the tooth root 10. The axis intersection angle may already be large enough to produce the protuberances 11 without a further feeding taking place. However, the tool can also be moved over a short distance in the axial direction, i.e., in the latitudinal direction of the toothing. The protuberances 11 then extend only over a portion across the entire width B of the tooth flank 8 and over a height that projects from the tooth root 10 to a root-shaped circle 9. During the second method step, the tooth flank between root-shaped circle 9 and tooth head 7 is not machined.

The protuberances 11 produced in this way thus extend over a portion of the tooth flank 8, which is spaced from the two end sides of the gearwheel 1. Protuberances 11 can extend to the tooth root. However, they can also extend over this to the core region of workpiece 1.

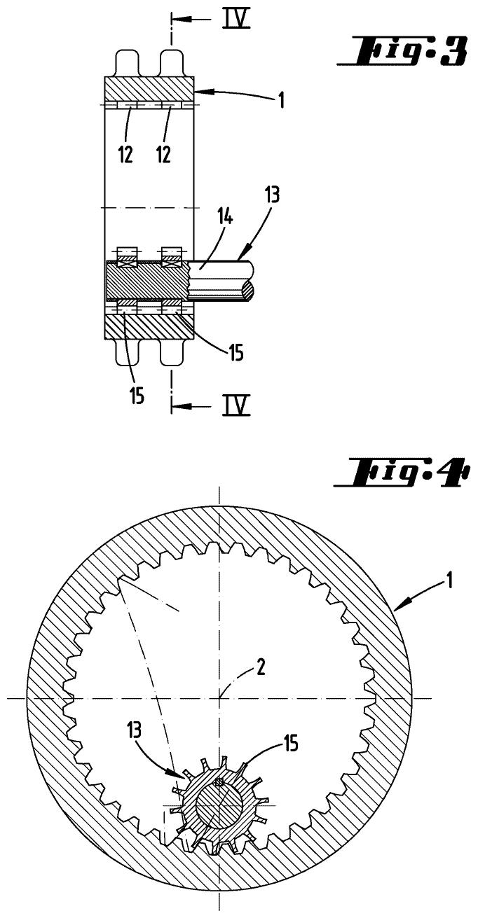

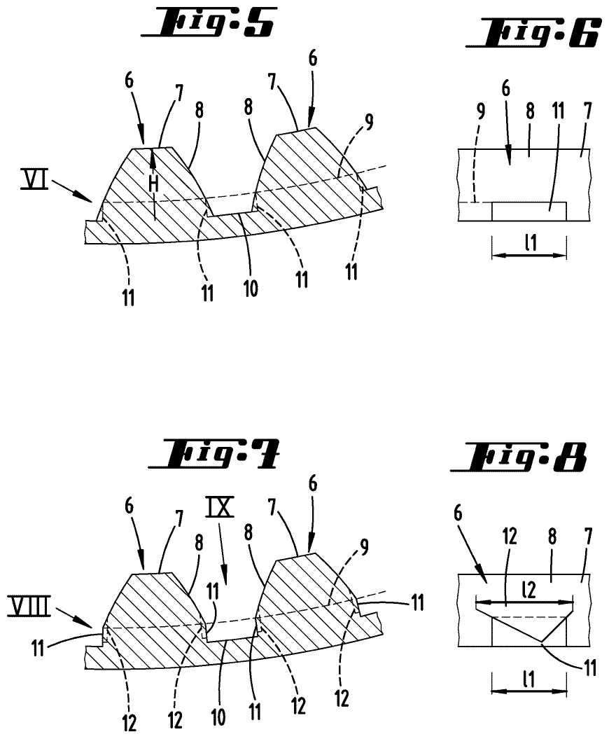

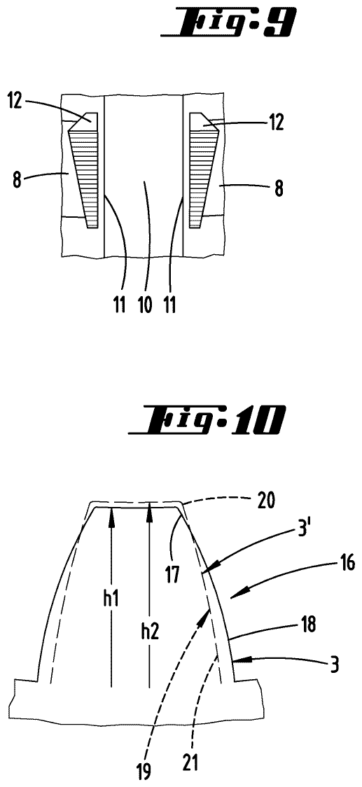

Following this second method step, a third tool, which is a undercutting tool, as shown in FIGS. 3 and 4, is used to cut undercuts 12 into the tooth flanks 8. The undercuts 12 are essentially incorporated into the tooth flanks 8 where the protuberances 11 were produced at the previous method step. However, the length 11 of the protuberance 11 measured in the width extension of tooth 6 may differ from the length 12 of undercut 12, which is also measured in the width extension of tooth 6. In the exemplary embodiment shown in the drawings, the length 11 of the protuberance 11 is slightly less than the length 12 of the undercut. In an exemplary embodiment (not shown), however, the ratios can be the other way around. However, the two lengths 11 and 12 can also be the same.

It may be favourable if the section of undercut 12 that lies between the tooth root 10 and the root-shaped circle 9 is completely within the range of a protuberance 11. It can therefore be provided, in particular, that the total width extension 12 of the undercut 12 is greater than the width extension 11 of the protuberance 11, but the width extension 11 which is greater than or at least equal to the width extension 12 of the undercut 12 in the region between the root-shaped circle 9 and the tooth root 10, wherein the position of the root-shaped circle 9 can be defined by the radial distance of an edge of the protuberance 11 from the tooth root 10.

The undercuts 12 can extend over a greater height extension in relation to the tooth height h₁, h₂ than the protuberances 11. In the exemplary embodiment, undercuts 12 do not extend to the region of the tooth root 10. However, it can also be provided that the undercuts 12 extend into the region of tooth root 10 or over the region of tooth root 10 into the core region of workpiece 1.

FIG. 10 shows the contours of the cutting edges 16 of a first hob peeling tool 3 and the cutting edges 19 of a second hob peeling tool 3′ positioned one above the other. In the region 18, 21 of the cutting edges 16, 19, in which the first hob peeling tool 3 machines the tooth flank 8 adjacent to the tooth head 7, the contour differs in that the section 18 of the first hob peeling tool 3, which machines the tooth flank 8 adjacent to the tooth head 7, is thicker than the corresponding section 21 of the second hob peeling tool 3′. With the cutting tooth produced the protuberances 11, the tooth flanks 8 are therefore not machined.

The regions 17, 20 of the cutting edges 16, 19, which in the region of the tooth root 10 enter into the cutting engagement on workpiece 1, differ in that the head section 20, which produces the protuberances 11, is thicker than the head section 17, which produces the flank region of the tooth flanks 8 between the root-shaped circle 9 and tooth root 10 at the first method step.

The tooth flanks 8 can extend along an involute. The protuberances 11 can also extend along an involute, which, however, merges into the region of the tooth flank 8 between tooth head 7 and root-shaped circle 9 at the root-shaped circle, thereby forming a kink. However, the protuberances 11 extend only essentially over the portion of the tooth width, into which the undercuts 12 are also incorporated.

The preceding embodiments serve to explain the inventions covered by the application as a whole, which at least independently advance prior by means of the following combinations of features, wherein two, a plurality or all of these combinations of features can also be combined, namely:

A method which is characterized in that the protuberances 11 extend only over second portions 12 of the width B of the tooth 5, each of which has an overlapping region with the first portion 11.

A method characterized in that the toothing is produced by a hobbing machining method, hob peeling, hobbing or by shaping or broaching and/or that the protuberances 11 are produced by hob peeling, shaping, hobbing or with an end mill.

A method characterized in that the tooth flanks 8 are produced with a first tool, in particular, the hob peeling tool 3, the cutting edges of which 16 run along a first contour, and the undercuts are produced with a second tool, in particular, a hob peeling tool, the cutting edges of which 19 run along a second contour different from the first contour.

A method which is characterized in that the section 18 of the cutting edges 16 of the first tool 3 adjacent to the tooth head 7 working the region of the tooth flank 8 is thicker than the corresponding section 21 of the cutting edges 19 of the second tool 3′ and that the section 20 of the cutting edges 19 of the second tool 3′ machining the protuberances 11 is thicker than the corresponding section 17 of the first tool 3.

A method characterized in that the height h₁ of the cutting teeth forming the cutting edges 16 of the first tool 3 is smaller than the height h₂ of the cutting teeth forming the cutting edges 19 of the second tool 3′.

A method characterized by the fact that the undercuts 12 are produced by using a cutting edge tool with a machining process.

A device characterized in that control device 22 is set up in such a way that when the device is operated, a gearwheel 1 is produced in accordance with the method specified in any of the Claims 1 to 6.

A device which is characterized in that the second tool 3′ is a hob peeling tool, wherein the section 18 of the cutting edges 16 of the first tool 3 adjacent to the tooth head 7 and working the region of the tooth flank 8 is thicker than the corresponding section 21 of the cutting edges 19 of the second tool 3′ and that the section 20 of the cutting edges 19 of the second tool 3′ working the protuberances 11 is thicker than the corresponding section 17 of the first tool 3.

A device characterized in that the third tool 13 is a cutting edge tool that can be rotated around a workpiece axis 2 that can be rotated.

All disclosed features (on their own, but also in combination with each other) are essential to the invention. In the disclosure of the application, the disclosure contents of the related/enclosed priority documents (copy of the pre-application) shall hereby be fully included, and also concerning this purpose, features of these documents must be included in claims of the present application. The sub-claims, even without the features of a referenced claim, characterize with their features independent inventive further embodiments of the prior art, in particular, in order to make divisional applications on the basis of these claims. The invention specified in each claim can additionally have one or a plurality of the features set out in the above description, in particular, those provided with reference numbers and/or specified in the reference list. The invention also relates to designs in which some of the features mentioned in the above description are not realized, in particular insofar as they are recognisably dispensable for the respective purpose or can be replaced by other technically identical means.

### LIST OF REFERENCE NUMBERS

1 gearwheel
2 workpiece axis
3 first hob peeling tool
3′ second hob peeling tool
4 tool axis
5 toothing
6 tooth
7 tooth head
8 tooth flank
9 root-forming circle
10 tooth root
11 protuberance
12 undercut
13 cutting edge tool
14 tool axis
15 cutting edge
16 cutting edge of the gear cutting tool
17 cutting edge section
18 cutting edge section
19 cutting edge of protuberance tool
20 cutting edge section
21 cutting edge section
22 control device
Σ axis intersection angle
η angle of inclination
B width
h₁ height
h₂ height
l₁ portion length
l₂ portion length

1: A method for the producing of a gearwheel (1) comprising a first step, at which a toothing (5) comprising teeth (6) with tooth flanks (8) is produced, a second step, at which protuberances (11) are produced in a region between a tooth root (10) of the teeth (6) and a root-shaped circle (9) by a material-removing method, and a third step, at which undercuts (12) are produced in the tooth flanks (8) only in one or a plurality of first portions (I₁) of a width (B) of the toothing (5), wherein the protuberances (11) extend only over second portions (I₂) of the width (B) of the toothing (5), which second portions (I₂) each comprise an overlapping region with the first portion (I₁).

2: The method according to claim 1, wherein the toothing is produced by means of a hobbing machining method, hob peeling, hobbing or by shaping or broaching and/or wherein the protuberances (11) are produced by hob peeling, shaping, hobbing or with an end mill.

3: The method according to claim 2, wherein the tooth flanks (8) are produced with a first tool, cutting edges (16) of which run along a first contour and the undercuts are produced with a second tool, the cutting edges of which (19) run along a second contour different from the first contour.

4: The method according to claim 3, wherein a section (18) of the cutting edges (16) of the first tool (3) adjacent to the tooth head (7) that machines a region of the tooth flank (8) is thicker than a corresponding section (21) of the cutting edges (19) of the second tool (3′) and wherein the section (20) of the cutting edges (19) of the second tool (3′) that machines the protuberances (11) is thicker than a corresponding section (17) of the first tool (3).

5: The method according to claim 4, wherein a height (h₁) of the cutting teeth forming the cutting edges (16) of the first tool (3) is less than a height (h₂) of the cutting teeth forming the cutting edges (19) of the second tool (3′).

6: The method according to claim 1, wherein the undercuts (12) are produced by using a cutting edge tool using a material-removing method.

7: A device for the production of gearwheels (1) comprising:
a rotary driven first tool (3), comprising a tool for hobbing a workpiece, the first tool being configured to be driven by rotation around a tool axis of rotation and is designed to be used to produce a toothing (5) comprising teeth (6) with tooth flanks (8) by a hobbing movement,
a second tool (3′), which is designed to produce protuberances (11) in a region between a tooth root (10) of the teeth and a root-shaped circle (9) by material removal,
a third tool (13) which is designed to produce undercuts (12) in the tooth flanks (8), and
a control device for controlling the tools (3, 3′, 13), wherein the control device (22) is configured in such a way that, during operation of the device, a gearwheel (1) is produced in accordance with the method according to claim 1.

8: The device according to claim 7, wherein the second tool (3′) is a hob peeling tool, wherein the section (18) of the cutting edges (16) of the first tool (3) adjacent to a tooth head (7) machining the region of the tooth flank (8) is thicker than a corresponding portion (21) of the cutting edges (19) of the second tool (3′) and wherein a section (20) of the cutting edges (19) of the second tool (3′) machining the protuberances (11) is thicker than a corresponding section (17) of the first tool (3).

9: The device according to claim 7, wherein the third tool (13) is a cutting edge tool which is configured to be rotated around a parallel to a workpiece axis (2).

10. (canceled)

11: The method according claim 3, wherein the first tool and the second tool are hob peeling tools.
